(19) United States
(12) Patent Application Publication
(10) Pub. No.: US 2026/0159055 A1
(43) Pub. Date: Jun. 11, 2026

(54) SYSTEMS AND METHODS FOR INSTALLING A BOOSTER TO A VEHICLE

(71) Applicant: Tesla, Inc., Austin, TX (US)

(72) Inventors: Yongquan Yu, Kyle, TX (US); Kevin Lee, Fremont, CA (US)

(21) Appl. No.: 19/179,062

(22) Filed: Apr. 15, 2025

Related U.S. Application Data
(60) Provisional application No. 63/634,008, filed on Apr. 15, 2024.

(51) Int. Cl. B60T 13/567

(52) U.S. Cl. CPC B60T 13/5675

(57) ABSTRACT

A method for assembling a vehicle can include inserting a plurality of clips into a plurality of holes in a booster, wherein each clip is inserted into a respective hole in the booster; aligning the booster with a dash panel of the vehicle; connecting the booster to the dash panel by inserting the plurality of clips into a plurality of holes in the dash panel, wherein each clip is inserted into a respective hole in the dash panel; aligning a brake pedal of the vehicle with the booster; and tightening a plurality of nuts on a brake pedal side of the vehicle to secure the booster to the dash panel.

### CLAIM OF PRIORITY

This patent application claims the benefit of priority, under 35 U.S.C. Section 119(e) to Yongquan Yu, U.S. Patent Application Ser. No. 63/634,008, entitled “SYSTEMS AND METHODS FOR INSTALLING A BOOSTER TO A VEHICLE,” filed on Apr. 15, 2024, which is hereby incorporated by reference herein in its entirety.

### BACKGROUND

Brake boosters can be components of a braking system configured to amplify or boost a force applied to a brake pedal, such as to help reduce a required force to be applied to the brake pedal by the user. The output force can be used to apply brake pads of the vehicle to rotors of the vehicle to slow the vehicle during use.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an isometric view of an automotive vehicle, according to some examples.

FIG. 2 illustrates an isometric view of a portion of a brake assembly of an automotive vehicle, according to some examples.

FIG. 3 illustrates a side view of a portion of a brake assembly of an automotive vehicle, according to some examples.

FIG. 4 illustrates a side view of a portion of a brake assembly of an automotive vehicle, according to some examples.

FIG. 5 illustrates a side view of a portion of a brake assembly of an automotive vehicle, according to some examples.

FIG. 6 illustrates a schematic view of a method, according to some examples.

FIG. 7 illustrates a schematic view of a method, according to some examples.

### DETAILED DESCRIPTION

Embodiments of the present disclosure are directed to systems and methods for installing components to a vehicle that are otherwise generally cumbersome to install, such as a booster and brake pedal combination to a dash panel. Brake boosters are often connected to the brake pedal but can be relatively time consuming or difficult to install or connect. For example, when boosters are installed to the dash panel with the brake pedal, four studs with screw threads are generally used. One operator typically will hold the booster in front of the dash panel while a second operator aligns the brake pedal from inside the vehicle cabin (on the opposite side of the dash panel). Once the booster's studs with threads are aligned with and inserted into the holes in the dash panel, the second operator tightens nuts that secures the assembly in place. In another example, a single operator may align and insert the booster into the dash panel and temporarily secure it with temporary nuts. The operator would then need to move to the inside of the vehicle cabin, undo the temporary nuts, and insert the permanent nuts the affix both the brake pedal and the booster to the dash panel. Both of these options are time-consuming, expensive, and cumbersome and are therefore undesirable.

The systems and methods of this disclosure discuss a booster and mounting components, such as plastic clips, that can replace one or more studs of a booster that are often used for attachment to the dash panel. The plastic clips can include one or more mechanism that can clip or retain the booster in place on the dash panel. In other words, changes to the dash panel or other parts of the vehicle body are not necessary. This device and method therefore can allow a single operator to insert the booster into the dash panel (instead of multiple), saving cost and time and improving the ease of installation. Moreover, one side of the clip can be serviceable and can be re-used, helping to save on service cost.

The example of installing a booster to a dash panel in conjunction with a brake pedal module is one example of using the discussed device(s) and method(s) and the principles could be applied to other assembly processes, such as installing brake rotors onto hub bearings before calipers or wheels are installed. Screws are currently used to hold the rotor in place during assembly, but a clip could be utilized to click the rotor into place. In some examples, the side of the clip that can be serviceable can vary. For example, both sides can be serviceable, the right side only can be serviceable, and the left side only can be serviceable.

The above discussion is intended to provide an overview of subject matter of the present patent application. It is not intended to provide an exclusive or exhaustive explanation of the invention. The description below is included to provide further information about the present patent application.

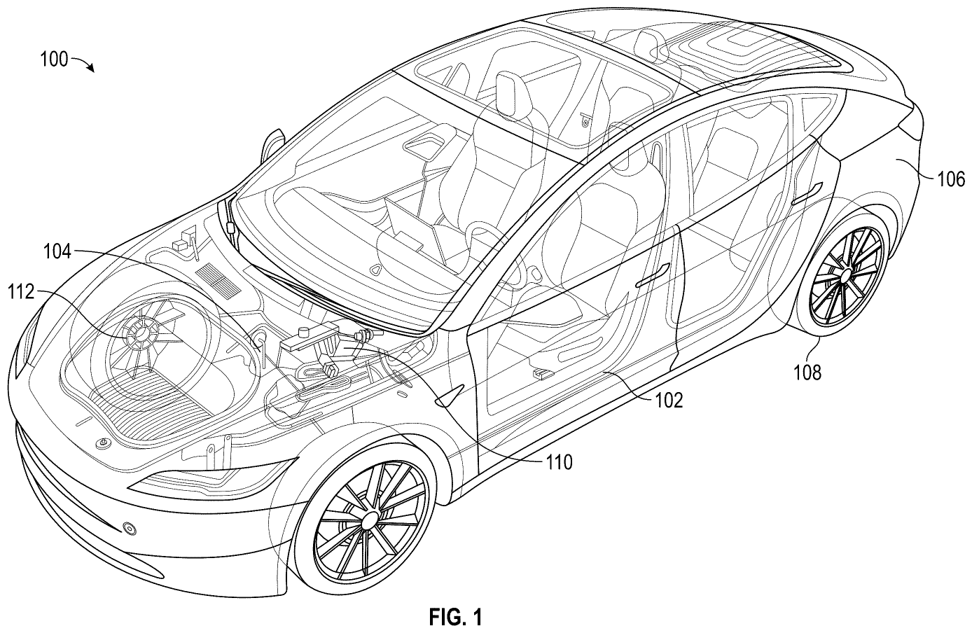

FIG. 1 illustrates an isometric view of an automotive vehicle 100, according to some examples. The automotive vehicle 100 can be a car, vehicle, automobile, or the like, operable to transport occupants or items over a road or other terrain. The automotive vehicle 100 can include a chassis 102, a drivetrain 104, panels 106, and wheels 108. The wheels 108 can engage with a road or terrain and can be configured to support the automotive vehicle 100. The chassis 102 can support the drivetrain 104, which can be connected to the wheels 108. The drivetrain 104 can be operable to drive the wheels 108 to rotate such as to move the automotive vehicle 100. The panels 106 can be connected to the chassis 102 and can help to reinforce the chassis 102 and improve drag or air resistance during transportation.

As discussed in further detail below, the automotive vehicle 100 can also include a brake booster 110 connected or connectable to a brake pedal within the cabin and configured to assist or increase a force applied to a pedal to a braking system 112 of the automotive vehicle 100. The brake booster 110 can be connected (electrically or hydraulically) to a master cylinder and can be connected to a regenerative braking system. The brake booster 110 can be connected to a brake pedal through a cabin wall, as discussed in further detail below.

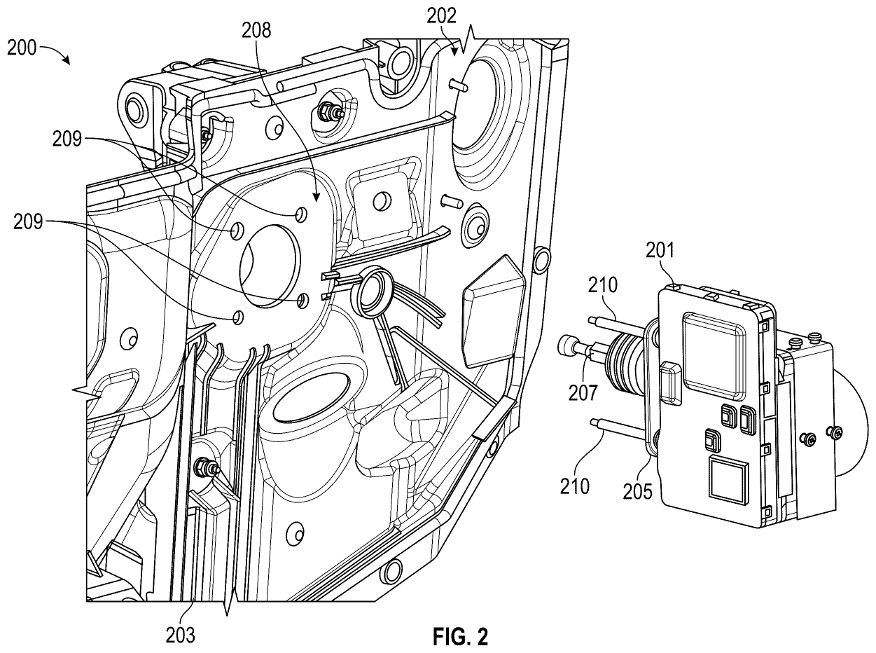

FIG. 2 illustrates an isometric view of a portion of a brake assembly or system 200 of the automotive vehicle 100, according to some examples. The system 200 can include a booster 201 (which can be the same as the brake booster 110 discussed above), a dash panel 202, and a brake pedal 203. The booster 201 can include studs 210 that can be modified to include or be replaced with clips (shown below). In addition, the dash panel 202 can include a connection section 208 that includes panel bores 209. The panel bores 209 can extend at least partially through the dash panel 202 and can be configured to receive the studs 210 and the plastic clips at least partially therein or at least partially therethrough. The connection section 208 allows the booster 201 to sit or mate flush with the dash panel 202, and the dash panel 202 can be become between a brake pedal module and the booster 201.

The dash panel 202 can include four of the panel bores 209, but can include fewer or more, such as 1, 2, 3, 4, 5, 6, 7, 8, 9, 10, or the like. In some examples, all of the panel bores 209 can be the same size and in other examples, the panel bores 209 can be of different sizes. In some examples, some of the panel bores 209 can be sized to receive the studs 210 and some of the panel bores 209 can sized to receive clips.

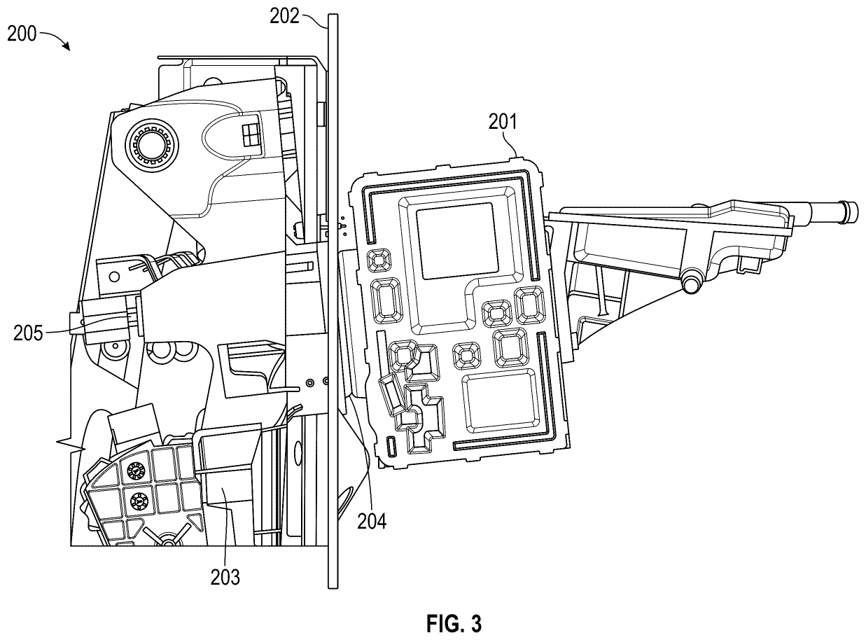

FIG. 3 illustrates a side view of a portion of the system 200, according to some examples. The system 200 of FIG. 3 can be consistent with the system 200 of FIG. 2 discussed above. FIG. 3 shows additional details of the system 200. For example, as shown in FIG. 3, the booster 201 can be inserted into dash panel 202. FIG. 3 also shows that the system 200 can include a plate 205 where the studs 210 can extend at least partially from the plate 205, such as away from the booster 201. The plate 205 can also include one or more plate bores, as discussed below.

The studs 210 and clips of the booster 201 extend at least partially within the panel bores 209 of the connection section 208 of the dash panel 202. This can help connect the brake pedal 203 to the booster 201 such as to allow a force applied to the brake pedal 203 to be delivered to a shaft 207 of the booster. Moreover, a pivot point 204 can be located at a bottom of the connection points of the booster 201 and the dash panel 202.

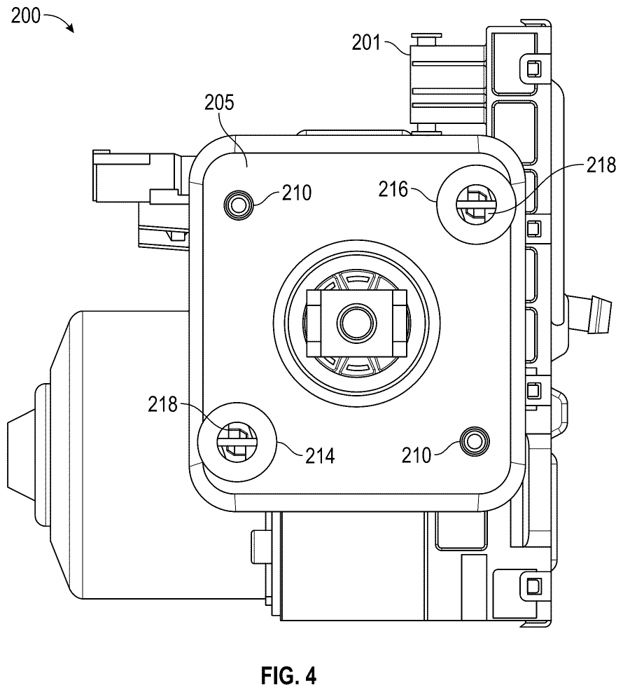

FIG. 4 illustrates a side view of the system 200, according to some examples. The system 200 of FIG. 4 can be consistent with the system 200 of FIGS. 2-3 discussed above. FIG. 4 shows additional details of the system 200. For example, as shown in FIG. 4, the plate 205 can include plate bores 218 extending at least partially into or partially through the plate 205. The clips 214 and 216 can be insertable at least partially into or partially through the plate bores 218 to secure the clips 214 and 216 to the plate 205 and therefore to the booster 201. The clips 214 and the clips 216 can optionally be included in the place of additional studs 110.

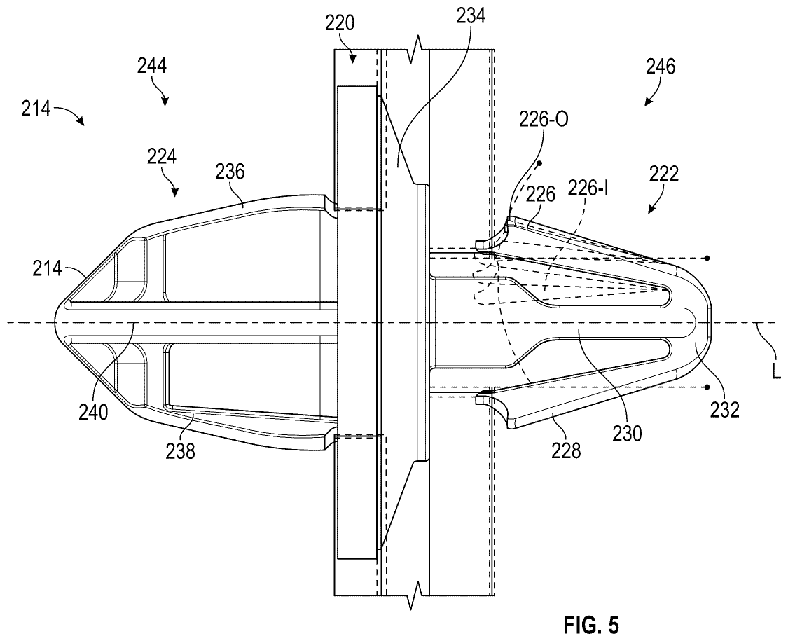

FIG. 5 illustrates a side view of the clip 214 (or clip assembly 214) of the system 200, according to some examples. Though the clip 214 is discussed, the clip 216 can have the same features as the clip 214. The system 200 of FIG. 5 can be consistent with the system 200 of FIGS. 2-4 discussed above. FIG. 5 shows additional details of the system 200.

For example, as shown in FIG. 5, the clip 214 can include a body 220, a first clip 222, and a second clip 224. The first clip 222 can be connected to the body 220 and can extend from the body 220 along the longitudinal axis L. The first clip 222 can be insertable into any of the plate bores 218 to secure the clip assembly 214 to the plate 205. The second clip 224 can be connected to the body 220 or the first clip 222 and the second clip 224 can extend from the body 220 along the longitudinal axis L, such as away from the first clip 222. The second clip 224 can be insertable into any of the panel bores 209 of the panel 202, such as to secure the clip 214, the plate 205, and the brake booster 201 to the panel 202.

FIG. 5 also shows that the first clip can also include a projection 226 and a projection 228 extending from a support 230. The projection 226 and the projection 228 can extend radially outward or away from the longitudinal axis. The projection 226 can extend outward or away from the longitudinal axis opposite the projection 228. Each of the projection 226 and the projection 228 can be movable between an inward position and an outward position. For example, the projection 226 can be movable between an inward position 226-I and an outward position 226-O. The projection 226 and the projection 228 can be configured to elastically deflect to the inward position and can be biased to return to the outward position. This can allow a nose 232 of the first clip 222 to be inserted into a bore (e.g., the plate bore 218) to cause the projection 226 and the projection 228 to deflect inward. Once the projection 226 and the projection 228 clear the bore (such as by extending entirely through the bore), the projection 226 and the projection 226 can extend or return to the outward position and can engage an opposite side of the plate 205, helping to limit or prevent the clips 214 from being removed from the plate 205 and thereby automatically securing the clips 214 to the plate 205.

The body 220 can also include a tapered portion 234 extending toward the first clip 222. The tapered portion 234 can be configured to insert into the plate bores 218 following insertion of the first clip 222 such as to countersink at least partially into the plate bore 218 and allowing the body 220 to be relatively flush with the plate 205 following insertion of the first clip 222.

The second clip 224 can include a first pair of wings, a wing 236 and a wing 238. The wing 236 can extend from the body 220 along the longitudinal axis L and can extend outward from the longitudinal axis L. Similarly, the wing 238 can extend from the body 220 along the longitudinal axis L and can extend outward from the longitudinal axis L, such as opposite the wing 236. The second clip 224 can include a second pair of wings that can extend orthogonally from the first pair of wings. For example, the second pair of wings can include a wing 240 and a wing 242 (visible in FIG. 4), which can be orthogonal to the wing 236 and the wing 238.

The second clip 224 can be releasably insertable into the panel bores 209 and can therefore be releasable from the panel bores 209. In some examples, the second clip 224 can be re-insertable into the panel bores 209 following removal of the second clip 224 from the panel bore. In this way, the clips 214 can be reusable such as following service of the booster 201.

The clip 214 can include a serviceable side 244 and a non-serviceable side 246. In some embodiments, however, both sides 244 and 246 can be serviceable. The non-serviceable side 244 can utilize a snap on mechanism to attach the clip 214 to the booster 201. The serviceable side 244 can be inserted into the panel bores 209 of the dash panel 202 to facilitate the connection thereof. In addition, the serviceable side 244 can be serviceable or otherwise removable, such as to perform repairs on any of the components therein. In some embodiments, the clip 214 may not be a separate component from the booster 201 and the dash panel 202. Rather, in some embodiments, the clip 214 can be built directly or integrally formed into one of the assembly components (either the booster 201 or the dash panel 202).

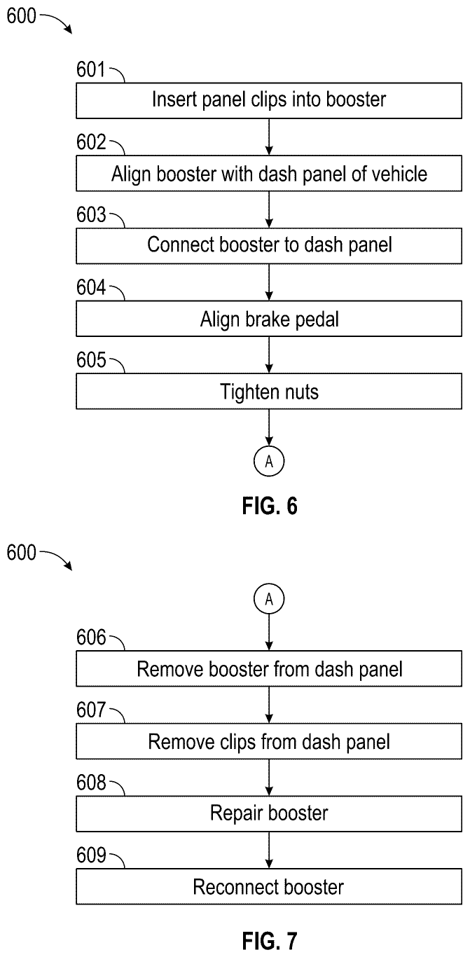

FIG. 6 illustrates a schematic view of a method 600, according to some examples. FIG. 7 illustrate a schematic view of the method 600, according to some examples. FIGS. 6 and 7 are discussed together below. The method 600 can be a method of installing a component of a dash panel or braking system. More specific examples of the method 600 are discussed below. The steps or operations of the method 600 are illustrated in a particular order for convenience and clarity; many of the discussed operations can be performed in a different sequence or in parallel without materially impacting other operations. The method 600 as discussed includes operations performed by multiple different actors, devices, or systems. It is understood that subsets of the operations discussed in the method 600 can be attributable to a single actor, device, or system could be considered a separate standalone process or method.

FIGS. 6 and 7 show an example installation process 600 according to some embodiments of the present disclosure. It is important to note that an operator or automated machine could perform one or more of the steps of process 600. The process 600 can begin at step 601 in FIG. 6, where an operator or automated machine inserts panel clips, such as the clips 214 and the clips 216, into the booster 201. At step 602, the booster 201 can be aligned with a dash panel 202 of a vehicle. For example, the studs 210 and clips 214 and 216 of the booster 201 can be aligned with the panel bores 209 of the dash panel 202. At step 603, the booster 201 can be connected to the dash panel 202. For example, the studs 210 and clips 214 and 216 can be inserted into the panel bores 209. The clips 214 and 216 can then be secured without additional tightening or maintenance. At step 604, the brake pedal 203 can be aligned with the dash panel 202. At step 605, one or more nuts can be connected to the studs 210 and tightened to secure the connection of the brake pedal 203 to the booster 201 with the dash panel 202 sandwiched in between.

FIG. 7 illustrates a second, optional part of the installation process 600, where the booster 201 can be removed for repairs or maintenance. At step 606, the booster 201 can be removed from the dash panel 202. At step 607, the clips 214 and 216 can be removed from the dash panel 202. It is important to note that the step of removing the clips 214 and 216 can be relatively simple because are removable service clips, rather than studs with threads tightened with nuts or other connection mechanisms. In addition, in some embodiments, removal of the clips can be an optional step. For example, removal of the clips can be performed if they are damaged as a result of the booster being removed from the dash panel. In addition, in some embodiments, removal of the clips can occur either before or after the booster is repaired. At step 608, the booster 201 can be repaired by any necessary means known to those in the industry. At step 609, the booster 201 can be reconnected to the dash panel 202 such as via the part of process 600 described in FIG. 6. In addition, the ease in which the booster 201 can be reconnected to the dash panel 202 after removal highlights another benefit of the principles disclosed herein.

### NOTES AND EXAMPLES

The following, non-limiting examples, detail certain aspects of the present subject matter to solve the challenges and provide the benefits discussed herein, among others.

Example 1 is a system for securing a brake booster to a panel of an automotive vehicle, the system comprising: a plate secured to a brake booster, the plate including a plate bore extending at least partially therethrough; a stud extending from the plate and insertable into a stud bore of a panel of an automotive vehicle; and a clip assembly including: a body; a first clip extending from the body and insertable into the plate bore to secure the clip assembly to the plate; and a second clip extending from the body and insertable into a panel bore of the panel to secure the plate and the brake booster to the panel.

In Example 2, the subject matter of Example 1 optionally includes wherein the first clip includes one or more projections movable between an inward position and an outward position, the one or more projections configured to elastically deflect to the inward position and biased to return to the outward position.

In Example 3, the subject matter of Example 2 optionally includes wherein the first clip is insertable into the plate bore in the inward position and the one or more projections are configured to move to the outward position following insertion to engage one or more of the plate bore and the plate to fasten the first clip to the plate.

In Example 4, the subject matter of any one or more of Examples 1-3 optionally include wherein the plate includes a second plate bore extending at least partially therethrough, and wherein the system includes a second clip assembly including a third clip and a fourth clip, the third clip insertable into the second plate bore to secure the second clip assembly to the plate.

In Example 5, the subject matter of Example 4 optionally includes wherein the fourth clip is insertable into a second panel bore of the panel to secure the plate and the brake booster to the panel.

In Example 6, the subject matter of Example 5 optionally includes wherein the second clip and the fourth clip are releasable from the panel bore and the second panel bore, respectively, and wherein the second clip and the fourth clip are re-insertable into the panel bore and the second panel bore, respectively, following removal of the second clip and the fourth clip from the panel bore and the second panel bore, respectively.

In Example 7, the subject matter of any one or more of Examples 1-6 optionally include a second stud extending from the plate and insertable into a second stud bore of the panel of the automotive vehicle.

In Example 8, the subject matter of any one or more of Examples 1-7 optionally include wherein the body of the clip assembly includes a tapered portion extending toward the first clip, the tapered portion configured to countersink at least partially into the plate bore.

In Example 9, the subject matter of any one or more of Examples 1-8 optionally include wherein the second clip extends along a longitudinal axis, and wherein the second clip includes a first pair of wings extending away from the longitudinal axis.

In Example 10, the subject matter of Example 9 optionally includes wherein the second clip includes a second pair of wings extending away from the longitudinal axis and orthogonally to the first pair of wings.

Example 11 is a method for assembling a vehicle comprising: inserting a plurality of clips into a plurality of holes in a booster, wherein each clip is inserted into a respective hole in the booster; aligning the booster with a dash panel of the vehicle; connecting the booster to the dash panel by inserting the plurality of clips into a plurality of holes in the dash panel, wherein each clip is inserted into a respective hole in the dash panel; aligning a brake pedal of the vehicle with the booster; and tightening a plurality of nuts on a brake pedal side of the vehicle to secure the booster to the dash panel.

In Example 12, the subject matter of Example 11 optionally includes wherein inserting the plurality of clips comprises inserting a plurality of panel clips.

In Example 13, the subject matter of Example 12 optionally includes wherein the plurality of panel clips is made of plastic.

In Example 14, the subject matter of any one or more of Examples 11-13 optionally include wherein inserting the plurality of clips comprises inserting a plurality of panel clips.

In Example 15, the subject matter of any one or more of Examples 11-14 optionally include wherein the booster comprises a first hole and a second hole for receiving the plurality of clips.

In Example 16, the subject matter of Example 15 optionally includes wherein the first hole is placed in a first corner of the booster and the second hole is placed in a second corner of the booster opposite the first corner.

In Example 17, the subject matter of any one or more of Examples 12-16 optionally include wherein each of the plurality of panel clips comprises a first end that enters the dash panel and a second end that remains on the booster.

In Example 18, the subject matter of Example 17 optionally includes wherein the second end comprises a snap on mechanism.

In Example 19, the subject matter of any one or more of Examples 17-18 optionally include removing the first end of each of the plurality of clips from the dash panel; and removing the booster from the dash panel.

In Example 20, the subject matter of Example 19 optionally includes repairing the booster; and reconnecting the booster to the dash panel.

In Example 21, the apparatuses or method of any one or any combination of Examples 1-20 can optionally be configured such that all elements or options recited are available to use or select from.

According to one aspect of the present disclosure, a method for assembling a vehicle can include inserting a plurality of clips into a plurality of holes in a booster, wherein each clip is inserted into a respective hole in the booster; aligning the booster with a dash panel of the vehicle; connecting the booster to the dash panel by inserting the plurality of clips into a plurality of holes in the dash panel, wherein each clip is inserted into a respective hole in the dash panel; aligning a brake pedal of the vehicle with the booster; and tightening a plurality of nuts on a brake pedal side of the vehicle to secure the booster to the dash panel.

In some embodiments, inserting the plurality of clips can include inserting a plurality of panel clips. In some embodiments, the plurality of panel clips can be made of plastic. In some embodiments, inserting the plurality of clips can include inserting a plurality of panel clips. In some embodiments, the booster can include a first hole and a second hole for receiving the plurality of clips. In some embodiments, the first hole can be placed in a first corner of the booster and the second hole can be placed in a second corner of the booster opposite the first corner.

In some embodiments, each of the plurality of panel clips can include a first end that enters the dash panel and a second end that remains on the booster. In some embodiments, the second end can include a snap on mechanism. In some embodiments, the method can include removing the first end of each of the plurality of clips from the dash panel; and removing the booster from the dash panel. In some embodiments, the method can include repairing the booster; and reconnecting the booster to the dash panel.

1The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.1

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A system for securing a brake booster to a panel of an automotive vehicle, the system comprising:
a plate secured to a brake booster, the plate including a plate bore extending at least partially therethrough;
a stud extending from the plate and insertable into a stud bore of a panel of an automotive vehicle; and
a clip assembly including:
a body;
a first clip extending from the body and insertable into the plate bore to secure the clip assembly to the plate; and
a second clip extending from the body and insertable into a panel bore of the panel to secure the plate and the brake booster to the panel.

2. The system of claim 1, wherein the first clip includes one or more projections movable between an inward position and an outward position, the one or more projections configured to elastically deflect to the inward position and biased to return to the outward position.

3. The system of claim 2, wherein the first clip is insertable into the plate bore in the inward position and the one or more projections are configured to move to the outward position following insertion to engage one or more of the plate bore and the plate to fasten the first clip to the plate.

4. The system of claim 1, wherein the plate includes a second plate bore extending at least partially therethrough, and wherein the system includes a second clip assembly including a third clip and a fourth clip, the third clip insertable into the second plate bore to secure the second clip assembly to the plate.

5. The system of claim 4, wherein the fourth clip is insertable into a second panel bore of the panel to secure the plate and the brake booster to the panel.

6. The system of claim 5, wherein the second clip and the fourth clip are releasable from the panel bore and the second panel bore, respectively, and wherein the second clip and the fourth clip are re-insertable into the panel bore and the second panel bore, respectively, following removal of the second clip and the fourth clip from the panel bore and the second panel bore, respectively.

7. The system of claim 1, comprising:
a second stud extending from the plate and insertable into a second stud bore of the panel of the automotive vehicle.

8. The system of claim 1, wherein the body of the clip assembly includes a tapered portion extending toward the first clip, the tapered portion configured to countersink at least partially into the plate bore.

9. The system of claim 1, wherein the second clip extends along a longitudinal axis, and wherein the second clip includes a first pair of wings extending away from the longitudinal axis.

10. The system of claim 9, wherein the second clip includes a second pair of wings extending away from the longitudinal axis and orthogonally to the first pair of wings.

11. A method for assembling a vehicle comprising:
inserting a plurality of clips into a plurality of holes in a booster, wherein each clip is inserted into a respective hole in the booster;
aligning the booster with a dash panel of the vehicle;
connecting the booster to the dash panel by inserting the plurality of clips into a plurality of holes in the dash panel, wherein each clip is inserted into a respective hole in the dash panel;
aligning a brake pedal of the vehicle with the booster; and
tightening a plurality of nuts on a brake pedal side of the vehicle to secure the booster to the dash panel.

12. The method of claim 11, wherein inserting the plurality of clips comprises inserting a plurality of panel clips.

13. The method of claim 12, wherein the plurality of panel clips is made of plastic.

14. The method of claim 11, wherein inserting the plurality of clips comprises inserting a plurality of panel clips.

15. The method of claim 11, wherein the booster comprises a first hole and a second hole for receiving the plurality of clips.

16. The method of claim 15, wherein the first hole is placed in a first corner of the booster and the second hole is placed in a second corner of the booster opposite the first corner.

17. The method of claim 12, wherein each of the plurality of panel clips comprises a first end that enters the dash panel and a second end that remains on the booster.

18. The method of claim 17, wherein the second end comprises a snap on mechanism.

19. The method of claim 17 comprising:
removing the first end of each of the plurality of clips from the dash panel; and
removing the booster from the dash panel.

20. The method of claim 19 comprising:
repairing the booster; and
reconnecting the booster to the dash panel.
